(19) United States
(12) Patent Application Publication
(10) Pub. No.: US 2021/0274753 A1
(43) Pub. Date: Sep. 9, 2021

(54) Animal Leash Device

(71) Applicant: Bandit Training Solutions LLC, Alexandria, VA (US)

(72) Inventor: Joshua Ira Altman, Arlington, VA (US)

(73) Assignee: Bandit Training Solutions LLC, Alexandria, VA (US)

(21) Appl. No.: 17/196,419

(22) Filed: Mar. 9, 2021

Related U.S. Application Data
(60) Provisional application No. 62/986,931, filed on Mar. 9, 2020.

(51) Int. Cl. A01K 27/00

(52) U.S. Cl. CPC A01K 27/005; A01K 27/003

(57) ABSTRACT

The present invention generally relates to leashes for controlling or leading an animal, and more particularly to an animal training leash configured to prevent entanglement of the leash. In brief, a first cord is connected to a first element of a rotatable component while a second cord is connected to a second element of a rotatable component. Each element of the rotatable component operates independently of the other element.

### RELATED APPLICATIONS

This application claims the benefit of U.S. Provisional Patent Application No. 62/986,931 filed on Mar. 9, 2020, which is hereby incorporated by reference in its entirety.

### FIELD OF THE INVENTION

The present invention generally relates to leashes for controlling or leading an animal, and more particularly to an animal training leash configured to reduce or prevent tangling of the leash.

### BACKGROUND

Animal leashes are known in the art for providing a means to lead and restrain animals. Prior developed animal leashes traditionally comprise a handle, a rope and a fastener to attach to the animal collar or harness. Prior developed leashes lack the ability to enable a user to control the length of the leash, provide enhanced attachment to the leashed animal, prevent the tangling of the leash during its use, or provide a means to substantially neutralize the force applied to the leash by a collared, haltered harnessed, or otherwise secured animal.

The present invention is an animal leash device which may be configured to provide enhanced attachment to an animal and to reduce or prevent tangling of the leash. These and other features and advantages of the present invention will be explained and will become obvious to one skilled in the art through the summary of the invention that follows.

### SUMMARY

Apparatus and associated methods relate to an animal leash. In an illustrative example, the animal leash may be a leash body connected to an attachment mechanism comprising a rotatable component having a cord running therethrough configured with two fasteners, each fastener adapted to attach to an animal harness. The rotatable component may be, for example, a swivel axis component having a first opening and a second opening, the swivel axis component permitting the rotation of the first opening independently from the second opening. In some examples, the first opening of the swivel axis component may be adapted to receive a first cord and the second opening of the swivel axis may be adapted to receive a second cord. For example, the second cord may movably couple to the second opening of the swivel axis component between the first and second ends of the second cord. Various examples may advantageously provide dual connection to an animal harness through fasteners extending from the first and second ends of the second cord to provide secured attachment to the harnessed animal.

Various embodiments may achieve one or more advantages. For example, some embodiments may provide increased securement of the leash to an animal, for example, a dog. This facilitation may be a result of the ability to attach the leash to both a dog harness and collar. Some embodiments may maintain attachment of the leash to the dog collar, even if the dog has managed to escape from its harness. Such securement of the leash to both the dog collar and harness may improve a user's dog walking experience.

In some scenarios, the effort required by a user to adjust the leash while walking the user's dog may be reduced. For example, a user who desires to give his or her dog more freedom during their walk, may opt to use a first handle, disposed farther from the harness attachment mechanism, to lead the user's dog. In other examples, a user who desires to more closely control the user's dog may use a second handle disposed closer to the harness attachment mechanism, to lead the user's dog. Furthermore, the configuration of the harness attachment mechanism, utilizing a rotation component, provides more flexibility to a dog attached to the leash via a harness. In some examples, the leash may be used with reactive dogs, or dogs being trained in general leash skills. In some scenarios, the rotation mechanism may be configured to reduce or prevent the tangling of a leash around itself when, as examples, the leash is being so utilized to train a dog or secure a dog in an environment where it may be stimulated. Because constantly untangling a leash during training, when the dog is most agitated creates a safety risk, having a leash configured with a rotation mechanism that reduces or avoids tangling, improves safety for the person holding the leash, the dog, and persons near or surrounding the dog.

According to some embodiments, the animal leash device comprises of a first cord, a second cord, a rotatable component, and a cord link. The rotatable component has two opening at opposite, latitudinal ends. Each end rotates independently of the other. A first cord is received on one end of the rotatable component while a second cord is received on the other, opposite end of the rotatable component. A cord link, which operates as a fail-safe, is connected to an end of the second cord. The cord link may be flanked by fasteners on both sides. This enables the cord link to connect to the animal leash device by means of the second cord on one end and to the animal's collar or harness on the other end. In certain embodiments, the cord link is attached to the second cord by means of at least one fastener. As an example, the second cord may be affixed to a carabiner which is able to receive an end of the cord link.

According to other embodiments, the invention comprises of a leash body, a rotatable component, and a harness attachment mechanism. In such embodiment, the leash body comprises of a first cord and a handle. In detail, one or more cords (hereinafter “the first cord”) may terminate in a loop at each end. At a first loop, the first cord connects to a handle by means of a fastener. At the second, opposite-ended loop, the first cord connects to the rotatable component by means of a connection joint; specifically in one embodiment the connection joint may thread through the loop. The rotatable component is connected to the leash body by means of a connection joint at a first end of the rotatable component. In greater detail, the rotatable component comprises of a cavity at a first end to which the connection joint attaches. In alternate embodiments, the rotatable component may terminate in additional points for attachment to adjoin elements (e.g. connection joints, second cord, etc.). The rotatable component on the opposite side (i.e. second end) connects to the harness attachment mechanism. The harness attachment mechanism comprises of a system of one or more cords, one or more cord links, and one or more fasteners. In embodiments, the harness attachment mechanism attaches to the rotatable element by means of the second cord. The second cord is connected to the rotatable element such that it can freely move without altering the position of the rotatable component. This enables the animal to move without impacting how the animal is secured by means of the leash body.

According to embodiments of the invention, the rotatable component is comprised of at least two elements or body members that rotate independently of one another. In certain embodiments, the rotatable component is a single tool such as a swivel axis (or axis swivel). In other embodiments, the rotatable component comprises of two different tools fastened together in a manner that retains each tool's independent movements. According to certain embodiments, the animal leash device may comprise of more than one rotatable component.

According to embodiments of the invention, the first cord may be linked to the rotatable component by means of a connection joint. A benefit of this embodiment is that first cords of various lengths may be substituted depending on the animal size and areas of use. As an illustration, if the invention is to be used with a small dog breed, it may preferable for the first cord to be relatively large. However, in a different scenario such as in a busy environment where the user would want to keep the dog close, it may be preferable to have a shorter cord.

According to embodiments, the invention comprises of a harness attachment mechanism. The harness attachment mechanism comprises of one or more cords that connect to the rotatable component (hereinafter “second cord”). In embodiments, the second cord may be threaded through a cavity at a second end of the rotatable component. The second cord may be connected to the animal at two points. In some embodiments, an end of the second cord is attached to the animal's collar while the other end is attached to the animal's harness. In alternate embodiments, the aforementioned connections occur with the second cord affixed to a fastener at each end and wherein each fastener is connected to the animal (e.g. at the collar and harness). In yet further embodiments, an end of the second cord may directly or by means of a fastener connect to a cord link. In such case, the cord link connects to the animal harness.

According to embodiments, the animal leash device may include at least one handle, but preferably two. A first handle may be configured upon an end of a first cord. The second handle may be configured upon the connection joint between the first cord and the rotatable component. In detail, the first cord and rotatable component may be connected by means of a connection joint. In such embodiment, the second handle may be connected to the connection joint. In alternate embodiments, the first cord is directly connected to the rotatable component. In such embodiments, the second handle may extend from the connection joint at the juncture of the first cord and the rotatable element. In alternate embodiments, the second handle may connect to one or more rotatable elements. In as yet further embodiments, the second handle is connected to the rotatable component by means of a second multi-axis rotatable component. In as yet further embodiments, the second handle is connected to the second cord by means of a second rotatable component which may move freely on one or more axes through which the second cord can pass through freely.

The details of various embodiments are set forth in the accompanying drawings and the description below. Other features and advantages will be apparent from the description and drawings, and from the claims.

### BRIEF DESCRIPTION OF THE DRAWINGS

Embodiments of the present invention will now be described, by way of example only, with reference to the following diagram wherein:

FIG. 1 shows an animal leash device in accordance with an embodiment of the present invention.

FIG. 2 shows a close view of a rotatable mechanism in accordance with an embodiment of the present invention.

FIG. 3 shows a close up view of a second handle in accordance with an embodiment of the present invention.

FIG. 4A shows a close up view of a first end of the harness attachment mechanism in accordance with an embodiment of the present invention.

FIG. 4B shows a close up view of a second end of the harness attachment mechanism in accordance with an embodiment of the present invention.

FIG. 5 shows a close up view of a cord link in accordance with an embodiment of the present invention.

### DETAILED DESCRIPTION OF ILLUSTRATIVE EMBODIMENTS

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

In accordance with embodiments of the present invention, an animal leash device may comprise three main components: a leash body, a rotatable component, and a harness attachment mechanism. According to embodiments, the leash body is configured to allow the (human) operator to secure the animal by means of handles. In the preferred embodiments, the leash body is adjoined to a rotatable component. This component provides independent movement to the animal without interfering with the operators handling of the animal. Notably, the rotatable component allows the animal rotate and slide along the rotatable component while the operator has uninterrupted control of the animal. In the preferred embodiment the rotatable component is configured laterally such that it is adjoined to the harness attachment mechanism on one side at zero degrees (0°) and to the leash body on the other side at one hundred eighty degrees (180°). Lastly, the harness attachment mechanism is configured to fasten to an animal harness and allow the animal leash device to bind securely to the animal.

In the preferred embodiment of the invention, the first cord of the leash body is fitted through a first body member of the rotatable component. Likewise, the second cord of the harness attachment mechanism is fitted to a second body member of the rotatable component in a manner by which the second cord can freely pass through the second member of the rotatable component. Each end of the second cord is fastened to the animal at a connection point (e.g. collar and harness). The first end of the second cord is affixed to both the first end of a cord link and together these are attached to the animal at a connection point. The second end of the second cord is attached at an animal connection point and the second end of the cord link is connected to the animal at yet a third connection point. The second handle of this embodiment may be variably situated and fastened. As an example, it may connected at the connection point of the first cord and the rotatable component by means of a ring attachment. As another example, the second handle may extend from a second rotatable component connected to the second cord which may rotate on one or more axes and through which the second cord can pass through freely.

The leash body may comprise one or more first cords and one more handles. In an illustrative example, the handle is directly connected to an end of the first cord. In such embodiments, the handle may be sewn to an end of the first cord or connected by means of an adhesive. In another embodiment, the first cord, comprising of a cap with an elongated hollow cavity at an end is threaded through a fastener (e.g. a carabiner) that connects to the handle. In yet another embodiment, the handle is natively part of the first cord and formed as a loop by means of one or more knots, sewing, or through other means. It will be apparent to a person skilled in the arts to configure or adapt a cord that is capable of connection by various means.

In the preferred embodiment, the other end of the first cord is attached to the rotatable component. Attachment to the rotatable component may be direct such that the first cord is connected to the rotatable component. In alternate embodiments the first cord is connected to the rotatable component by a connection joint.

In alternate embodiments where the first cord is comprised of multiple cords (wherein each individual cord is hereinafter referred to as “first mini-cord”), at least one first mini-cord connects to an end of the rotatable component while the other first mini-cords are connected to other features of the claimed invention. In embodiments, the group of first mini-cords act in concert with one another such that they are connected at the same ends to the same objects. However, in other embodiments, each first mini-cord may be connected to disparate components (e.g. some may be connected to connection joints, some may be connected to the rotatable elements, etc.). In further embodiments, some first mini cords act in concert with one another while other first mini cords act in complementary or supplementary fashion, supporting other first mini cords. Likewise, in alternate embodiments, the second cord is comprised of multiple cords (wherein each individual cord is hereinafter referred to as a “second mini-cord”). The second mini-cords may act as a bundle in lieu of a single second cord. Accordingly, the second mini-cords fit through the second end of a rotatable member. In embodiments, the second mini-cords bundle act in concert of each other. In alternate embodiments, the second mini-cords may be connected to disparate components. In further embodiments, some second mini cords act in concert with one another while other second mini cords act in complementary or supplementary fashion, supporting other second mini cords.

The connection joint may serve to join various features of the invention. In one embodiment, the connection joint connects the first cord to the rotatable component. In alternate embodiments, the connection joint may also be connected to a second handle. In some embodiments, another connection joint may be connected to a second handle and a harness attachment mechanism. Some embodiments may not include a connection joint.

The rotatable component may be, for example, a swivel axis component having a first opening and a second opening. In some scenarios, the swivel axis component facilitates the rotation of the first opening independently from the second opening. In some examples, the first opening of the swivel axis component may be adapted to receive a first cord and the second opening of the swivel axis may be adapted to receive a second cord. In the aforementioned configurations, the second cord may be movably or slidably coupled to the second opening of the swivel axis component between the first and second ends of the second cord. Various examples may advantageously provide dual connection to an animal harness through fasteners extending from the first and second ends of the second cord to provide secured attachment to a harnessed animal.

Generally, the rotatable component requires the ability to rotate freely in one or more directions. Embodiments of the invention may comprise a rotatable component wherein each element of the rotatable component may independently rotate three hundred and sixty degrees (360°) at a fixed axis or rotate such that there is no fixed axis. In certain embodiments, the rotatable component comprises of a design which facilitates a three hundred and sixty degree (360°) rotation for each rotatable element. According to another embodiment, a rotatable component is a cylindrical rod with at least two disparate body elements wherein each body element independently rotates along the rod. As one alternative to the swivel axis component, the rotatable component may be two separate spinner gated hooks, wherein one end is a closed loop and a second end is a gated hook. For use in the claimed invention, the gated hook ends interlock while the gated hook ends are ready for connection to a connection joint or directly to a cord. As with the swivel axis component, the attachment points for each cord are configured across from each other.

In the preferred embodiment, the rotatable component comprises of two rotatable members or elements. The first rotatable element is connected to the first cord while the second rotatable component is connected to the second cord. According to alternative embodiments of the current invention, the rotatable component may comprise of one or more elements. According to select embodiments, the rotatable element may comprise of disparate types of members. As an illustration, in one embodiment, the rotatable component may comprise of a swivel axis member and a multi-axis member. In such embodiment, the first cord is connected to a first rotatable element while the second cord is connected to a second rotatable element.

According to embodiments, the harness attachment mechanism connects to the animal's collar or harness. It comprises of at least one or more cords, fasteners, and cord links. According to one embodiment, the harness attachment mechanism comprises of a single cord that is connected to the rotatable component. One end of the cord comprises of fastener that is connected to a cord link. The cord link is configured to connect an animal harness, an animal collar, and the leash device to one another. In certain embodiments, the cord link comprises of a rope-like material that is able to extend when pulled. Each end of the cord link comprises of an attachment mechanism such as a gated hook or fastener that facilitates the connection of the cord link to the cord of the harness attachment mechanism on one end and a collar and/or harness on the other end.

In accordance with embodiments of the present invention, the animal leash device provides increased securement of the leash to an animal, for example, a dog. This facilitation may be a result of the ability to attach the animal leash device to both a dog harness and collar, for example, to maintain attachment of the animal leash device to the dog collar, even if the dog has managed to escape from its harness. Such securement of the device to both the dog collar and harness may improve a user's dog walking experience by, in some instances, reducing stress associated with walking dogs who have a propensity for escaping from their harness when pulling away from their owner or walker.

In accordance with embodiments of the present invention, the animal leash device may decrease the effort required by a user to adjust the leash while walking the user's dog. For example, a user who desires to give his or her dog more freedom during their walk, may opt to use a first handle, disposed farther from the harness attachment mechanism, to gently steer the dog in a generally desired direction. In other examples, a user who desires to keep his or her dog closer to the user may use a second handle disposed closer to the harness attachment mechanism, to handle his or her dog.

In accordance with embodiments of the present invention, the configuration of the harness attachment mechanism, which is conferred movement by means of the rotatable component, provides more flexibility in utility, and controlled range of motion, to a dog attached to a leash via a harness. In some examples, the leash may be used with reactive dogs or dogs being trained in general leash skills. In some scenarios, the rotation mechanism may be configured to reduce or prevent the tangling of a leash around itself when the leash is being so utilized to train a dog. Because constantly untangling a leash during training, when the dog is most agitated creates a safety risk, having a leash configured with a rotation mechanism that reduces or avoids tangling, improves safety for the person holding the leash, the dog, and persons near or surrounding the dog.

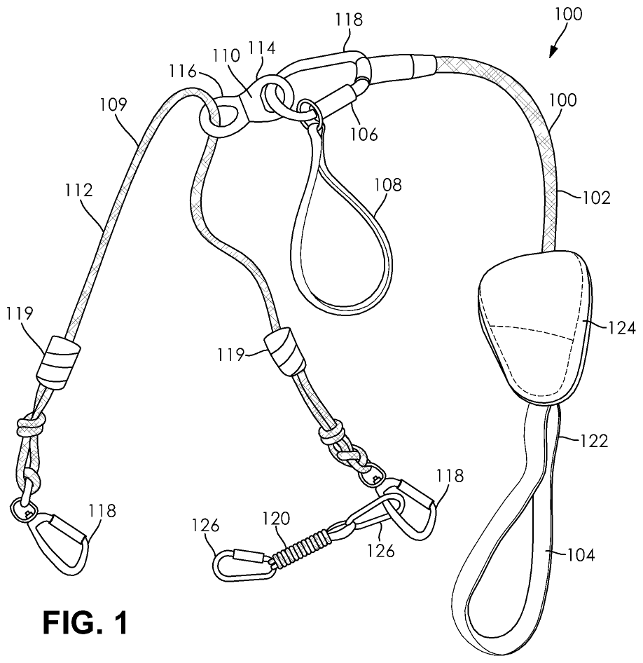

FIG. 1 depicts an animal leash device in accordance with an exemplary embodiment of the present invention. In the depicted example, the animal leash device 100 includes leash body comprising of a first cord 102 connected at a first end to a handle 104 and at a second end to a connection joint 106. In alternate embodiments, the leash body comprises of a group of cords. In such embodiments, at least two individual cords are enclosed together in a sheath, wrapper, or container to function as a single unit of cord. A loop (122) is fastened to an end of a first cord or group of cords. In some embodiments, the loop is attached to a handle (122). In alternate embodiments, the loop extends into a handle. The operator of the animal leash device may either slide a hand through and position the handle on the operator's wrist or grip the handle.

According to embodiments of the current invention, the rotatable component is a swivel axis component (110). In the preferred embodiment, the swivel axis component 110 connects the first cord 102 to the second cord 112 of the harness attachment mechanism. In the preferred embodiment, the swivel axis component 110 includes a first end having a first opening 114 and second end having a second opening 116, respectively. In some embodiments, the first end of the swivel axis component 110 is configured to connect with the first cord 102 and the second end of the swivel axis component 110 is configured to connect with the second cord 112 of the harness attachment mechanism. In the preferred embodiment, the first opening 114 of the swivel axis component receives the first cord 102 and the second opening 116 receives the second cord 112. The swivel axis component 110 may be configured such that the first end of the axis 110 may spin or rotate independently from the second end of the axis 110. In the preferred embodiment, the swivel axis component 110 is disposed between the first and second ends of the second cord 112.

According to alternate embodiments, the rotatable component comprises of at least two swivel axis components. In such embodiments, the swivel axis components may be connected to each other by means of a connection joint in a chain configuration. In such embodiment, the first cord is connected either directly to a first swivel axis component or connected by means of a connection joint. Likewise, at the opposite end of the chain of swivel axis components, the second cord is connected to a comparable second opening (116) of the last of the swivel axis components in the chain. In alternate embodiments with at least two swivel axis components, the first cord and second cord may be a group of first cords and a group of second cords. The number of cords may be dictated by the number of swivel axis components. Each individual first cord is connected (either directly or indirectly by means of a fastener) to a corresponding first opening (114) of a swivel axis component while each individual second cord is connected to a corresponding second opening (116) of the swivel axis component. One of ordinary skill in the art would appreciate that there are numerous configurations as to how each cord or group of cords are connected to one or more swivel axis components to maintain movement and secure fasten to the animal.

According to alternate embodiments, there may be one or more connection joints that connect a cord or a single unit of cord on one end to the rotatable component on the other end. In alternate embodiments, there are multiple connection joints that may be interlinked to one another forming a chain. In some embodiments, the connection joint 106 may be connected to a second handle 108. In embodiments with the second handle (108), this second handle yields an additional element of control of the animal. The second handle is closer to the animal since it configured near the harness attachment mechanism. This enables the operator to more easily and safely control an animal if the animal becomes unruly or is instigated by an external stimulus. In some embodiments, the connection joint 106 may be removably attached to the second handle 108 and the first cord (102) or group of first cords.

According to certain embodiments of the animal leash device, the first cord may be connected to the rotatable component directly without the need for a connection joint. In such embodiment, both the first cord and the second cord are threaded through their own openings of the rotatable component. In certain embodiments the rotatable component may comprise of extensions in the form of rings to facilitate the connection of a second handle (108).

In the depicted example, the first and second ends of the second cord 112 each includes a fastener 118. In some embodiments, there may be one or more fasteners. In the illustrated example, the fasteners 118 are carabiners. In some embodiments, the fasteners 118 may be configured to fasten a first end of the second cord 112 to a front portion of an animal harness and a second end of the second cord 112 to a back portion of the animal harness. One of ordinary skill in the art would appreciate that there are numerous fastener configurations which may be utilized to fasten the leash device to an animal harness and embodiments of the present disclosure are contemplated for use with any such fastener configuration.

According to embodiments of the invention, the invention comprises of a harness attachment mechanism that enables fastening of the invention to the animal. In embodiments, the harness attachment mechanism comprises of at least one cord (hereinafter “the second cord”), at least one fastener, and at least one cord link. Generally, the harness attachment mechanism is attached to one end of the rotatable component. As an illustration, the second cord is connected to the rotatable end, for example, by means of threading through an opening end. A cord link is attached to the second cord on one end which facilitates connecting the animal leash device to the animal's harness or collar. Meanwhile the other end of the second cord comprises of a fastener which also attaches to another animal accoutrement such as a collar or same accoutrement such as a body harness.

As further shown in FIG. 1, the leash device 100 comprises a cord link 120. In accordance with several embodiments, the first and second ends of the cord link 120 each include a fastening member 126. In accordance with several embodiments, the cord link 120 is configured to connect the harness attachment mechanism 109 to an animal collar and/or an animal harness. In an illustrative example, a fastening member 126 at the second end of the cord link 120 may be configured to connect the cord link 120 to an animal harness, a fastener 118 at the second end of the second cord 112 is connected to the animal's collar, and a fastening member 126 of the first end of the cord link 120 may be configured to connect the cord link 120 to an animal collar. One of ordinary skill in the art would appreciate that there are numerous fastening member configurations which may be utilized to fasten the leash device to an animal harness and collar and embodiments of the present disclosure are contemplated for use with any such fastening member configuration. In alternate embodiments, there are one or more cord links with one or more fasteners that may be of various types such as clips. When multiple cord links are present, they are may be in the form of a group of cord links arranged in a bundle or they may be arranged in linear fashion.

A benefit of the cord link is that it enhances a back attachment point between the animal leash device and the animal. Accordingly, at a most basic level, the connection points between the claimed invention and the animal are (i) a front attachment point of the animal to the invention by means of a collar or a front attachment point and an end of the second cord, (ii) a back attachment point by means of the rear of the harness on the animal and the cord link, and. Should one connection point break, there are additional points that remain connected.

In accordance with an exemplary embodiment of the present invention, the swivel axis component 110 is configured to move or slide freely along the second cord 112 which enables the claimed invention to apply the appropriate amount of force to safely handle the animal. Furthermore, the moveability of the swivel axis component provides flexibility in the attachment of the leash device 100 to a harness applied to an animal. In the illustrated example, the second cord 112 includes a stopper 119 at each of its first and second ends. In some embodiments, the stopper is configured to stop the second cord 112 from exiting from the second opening 116 of the swivel axis component 110, to prevent the fasteners from betting trapped, to prevent the cord pair or bundle (112) from sliding too far to one side of 106 and preventing 118 from getting caught in 106. In the depicted example, the first opening of the swivel axis component 110 is connected to a connection joint 106 which is configured to couple the first cord 102 to the swivel axis component 110 and the second handle 108. In some embodiments, the connection joint 106 may be configured to reversibly couple the first cord 102 to the swivel axis component 110 and the second handle 108. In some embodiments, the connection joint 106 is a carabiner. In some embodiments, the second handle 108, connected to the second cord 112 through the swivel axis component 110, provides a user of the leash device 100 with broad control of a harnessed animal secured to the leash device 100.

In accordance with an exemplary embodiment of the present invention, the second cord 112 may be used to harness two animals. For example, a first fastener 118 of the first end of the second cord 112 may attach to a harness or collar of a first animal, and a second fastener 118 of the second end of the second cord 112 may attach to a harness or collar of a second animal.

In some embodiments, the configuration of the leash device 100 provides a failsafe in case the harnessed animal breaks out of the harness. For example, if the leash device 100 is connected to both an animal harness and collar, the leash device 100 remains secured to the collar, even if the animal manages to escape from the harness.

In accordance with an exemplary usage scenario of the present invention, the animal leash device 100 may be applied to a dog harness by fastening a first fastener 118 of the attachment mechanism to a loop on a front portion of the dog harness and a second fastener 118 of the attachment mechanism 109 to a loop on a back portion of the dog harness. In some examples, this configuration of the leash device 100 facilitates the rotation of a leashed animal or dog when the dog pulls on the leash 100, such that the leashed animal or dog may be rotated to face the holder of the leash. In some scenarios, the leash assists the leash holder in redirecting the dog or animal as desired by the leash holder, for example, away from a reactivity trigger, and, as appropriate, towards positive reinforcement. Moreover, connection of the leash 100 to the front and back of a harness gives greater control of the leashed animal than when the leash is only connected on either the front or the back of the harness. In some scenarios, a first fastening member 126 of the cord link 120 may attach to a fastener on the second cord 112, and the second fastening member 126 of the cord link 120 may attach to a dog collar, for example, through a loop disposed on a dog collar. In some scenarios, if the harness rips or tears, the cord link 120 may still be attached to the leash 100. In some examples, if the animal slips out of the harness, then the leash 100 may still be attached to the cord link 120 which is attached to the animal collar.

In some examples, the swivel axis component 110 is configured to move or slide along the second cord 112. In an illustrative example, if a dog pulls against the leash 100, the swivel axis component 120 may travel along the second cord 112, while the first cord 102 and handle 108 substantially maintains its angle and placement, no matter how hard or in what direction the dog is pulling, thereby easing or lessening the force applied on the dog walker by the pulling dog. In some scenarios, this configuration increases the comfort level associated with walking a dog.

In some embodiments, the leash device 100 includes a storage element. In the illustrated embodiment, the storage element comprises a loop 122 configured to receive hooks or other fastening mechanisms to fasten accessories to the leash body. For example, a storage bag 124 may be fastened to the animal leash device.

According to certain embodiments of the invention, each component of the animal device is connected in a reversibly removable fashion. This allows a worn component to be easily replaced without discarding the entire invention. As an illustration, if a first cord is worn—perhaps due to the animal gnawing on it—the first cord can be removed from a connection point by undoing a fastener. The first cord is then replaced with a new cord.

According to embodiments of the current invention, at least one cord is adjustable, for example, it can capable of retraction. In the preferred embodiment, the first cord of the leash body is configured to a braking system. Specifically the first cord is wound around a spool within a braking system, enabling adjustments in length of the cord. Likewise, the loop-end of the handle is connected to an extendable or retracting system that operates in tandem with the first cord.

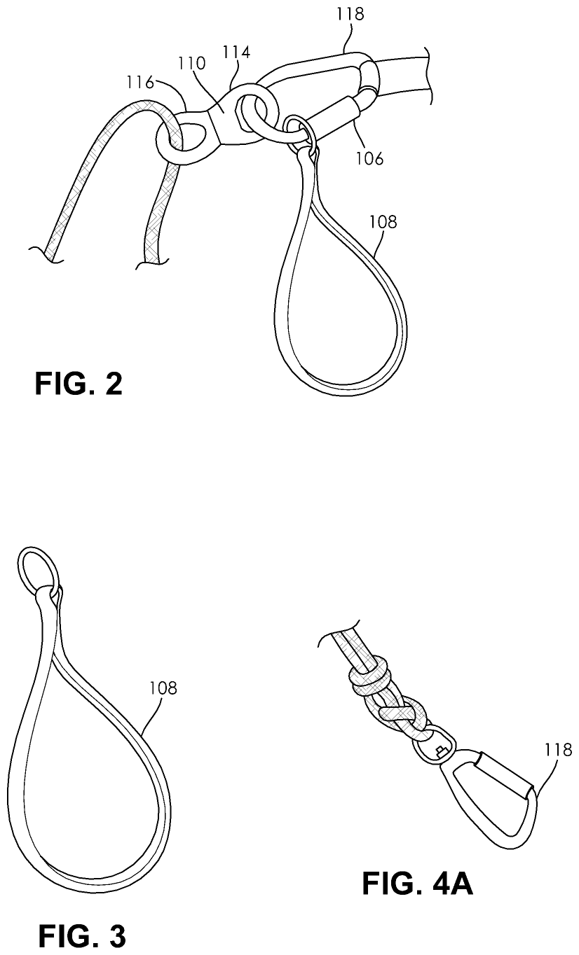

Turning to FIG. 2 is a close up, examined view of the rotatable mechanism (110) attached to a connection point on first end and a cord of the harness attachment mechanism (not labeled) on an opposite end. As depicted herein, the rotatable component comprises of a first independent member with an aperture (114) loosely secured to a second independent member with an aperture (116) such that each independent member may spin in 360 degree configuration. A connection joint (106) is threaded through an independent member facilitating connection of the leash body to the rotatable mechanism. In alternate embodiments, the leash body mechanism may comprise of a cord terminating in a fastener such as loop comprising of hook and loop fastener that reversibly threads through a member of the rotatable mechanism. In such alternate embodiment, the second handle (108) may be attached to the leash body directly or the rotatable mechanism rather than a connection joint.

In additional embodiments, the connection joint (106) may comprise of a group of one or more connection joints. In one embodiment, the addition and removal of connection joints provides a means of adjustability to the current invention. Depending on the size of dog, different lengths of the animal leash device may be necessary. By configuring at least two connection points in tandem row, the operator can easily adapt the invention to the operator's and the animal's comfort.

Turning to FIG. 3 is a close up view of a second handle (108). In specific detail, the second handle is comprised of a loop wrapped around an attachment ring. In some embodiments, the attachment ring is fixed the loop cannot be released from the ring. In alternate embodiments, the loop is comprised of a hook and loop fastener so that the second handle can be reversibly removed.

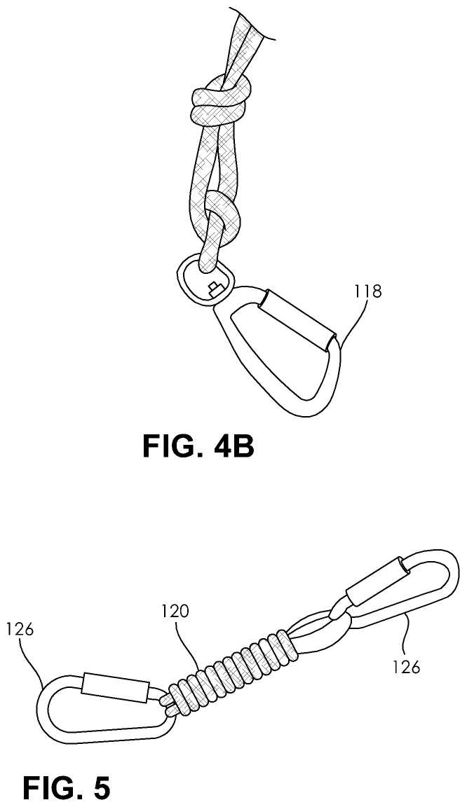

Turning to FIG. 4A and FIG. 4B are terminal ends of the second cord. Similar to the first cord, the terminal ends may comprise of a connection joint. In the illustrated embodiment, the connection joint is attached to an extendable/flexible cord in reversible fashion. Specifically the “gate” portion of the connection joint (e.g. a carabiners) may flip within the aperture of the connection joint.

Turning to FIG. 5 is the attachment element of the current invention. In the preferred embodiment, the attachment mechanism is a cord link that facilitates connection of the current invention to the animal's harness or collar. The cord link is rope-like in fashion since it comprises of sturdy material that is wound around one or more metal clips. This winding lends stability to the cord link and yields a limited amount of flexibility. Each end of the cord link (120) is further comprised of additional fastening mechanisms.

According to embodiments, there may be additional handles located throughout the invention or the handle locations may be translocated to other positions. As an illustration, a second handle may be connected directly to a rotatable component, one or more rotatable components, and a second cord.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, the term “connect” and variations thereof, may be mean direct physical connection or connection by means of a intermediary component just as a connection joint or fastener.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. An animal leash device comprising of:
a first cord, a second cord, a rotatable component, and a cord link;
wherein said rotatable component comprises of a first opening at a first end and a second opening at a second end, wherein said first end rotates independently of said second end;
wherein said first cord is received within said first opening of said rotatable component,
wherein said second cord is received within said second opening of said rotatable component,
wherein said cord link is affixed to a first fastener on a first end of said cord link and a second fastener on a second end of said cord link.

2. The animal leash device of claim 1 wherein said rotatable component is a swivel axis.

3. The animal leash device of claim 1 wherein said first cord is connected at a first end to a handle.

4. An animal leash device comprising of:
a first cord, a second cord, a rotatable component, and a cord link;
wherein said rotatable component comprises of a first opening at a first end and a second opening at a second end, wherein said first end rotates independently of said second end;
wherein said first cord is fastened to said first opening of said rotatable component by means of a first connection joint,
wherein said second cord is received within said second opening of said rotatable component,
wherein said cord link is affixed to a first fastener on a first end of said cord link and a second fastener on a second end of said cord link.

5. The animal leash device of claim 4 wherein said connection joint is connected to a second handle.

6. The connection joint of claim 5 wherein said connection joint is removable.

7. An animal leash device comprising of:
a leash body, a rotatable component, and a harness attachment mechanism,
wherein said leash body comprises of at least a first cord extending into a loop on each end, wherein said loop on the first end connects to or is a handle and wherein said loop on the second end connects to a connection joint,
whereby said connection joint is joined to said rotatable component, and
whereby said rotatable component receives a second cord of said harness attachment mechanism.

8. The harness attachment mechanism of claim 7 further comprising of a cord link fastened to an end of said second cord.

9. The animal leash device of claim 4 wherein said connection joint is connected to a second handle.

10. The connection joint of claim 5 wherein said connection joint is removable.

11. An animal leash device comprising of:
a rotatable component configured with a first body member and a second body member, wherein each body member rotates independently of the other body member,
wherein said first body member is configured to receive a first cord and wherein said second body member is configured to receive a second cord, and
wherein a first end and a second end of said second cord are configured with fasteners to attach to an animal accessory.

12. The animal leash device of claim 11, wherein said first body member is comprised of a cavity that receives first cord and wherein said second body member is comprised of a cavity to receive said second cord.

13. The animal leash device of claim 11, wherein said first cord is received by a first body member by means of a connection joint.

14. The animal leash device of claim 13, wherein said connection joint is further configured with a handle.

15. The animal leash device of claim 11 wherein an end of the first cord comprises of a handle.

16. The animal leash device of claim 13 further comprising of cord link.

17. The animal leash device of claim 16, wherein said cord link is affixed to an end of the second cord.

18. The animal leash device of claim 11 further comprising a storage bag.

19. The animal leash device of claim 18 wherein said storage bag is configured at an end of a first cord.

20. The animal leash device of claim 11 wherein said second cord is configured with fasteners at each end.
